(19) United States
(12) Patent Application Publication
(10) Pub. No.: US 2025/0249672 A1
(43) Pub. Date: Aug. 7, 2025

(54) FILM

(71) Applicant: BOREALIS AG, Vienna (AT)

(72) Inventors: Jingbo WANG, Linz (AT); Friedrich BERGER, Linz (AT); Arnaud ALABRUNE, Courbevoie (FR); Chantal SEMAAN, Barcelona (ES)

(21) Appl. No.: 18/855,036

(22) PCT Filed: Apr. 6, 2023
(86) PCT No.: PCT/EP2023/059199

§ 371 Date: Oct. 8, 2024

(30) Foreign Application Priority Data
Apr. 11, 2022 (EP) 22167659.6

(51) Int. Cl. B32B 27/32; B32B 27/08

(52) U.S. Cl. CPC B32B 27/327; B32B 27/08; B32B 2250/05; B32B 2250/242; B32B 2307/516; B32B 2307/72

(57) ABSTRACT

The invention provides a uniaxially oriented multilayer film comprising at least a sealing layer, a core layer and an outer layer, wherein at least one of said layers, preferably the sealing layer, comprises a metallocene-catalysed multimodal polyethylene terpolymer having a density in the range of from 910 to 916 kg/m³ and an MFR₂ (190° C., 2.16 kg, ISO 1133) in the range of from 0.1 to 2.5 g/10 min.

This invention relates to a uniaxially oriented film with beneficial mechanical and processing properties. In particular, the invention relates to an uniaxially oriented film, wherein at least one layer comprises a metallocene-catalysed multimodal polyethylene terpolymer. The invention further relates to the use of the metallocene-catalysed multimodal polyethylene terpolymer in the production of uniaxially oriented films.

### BACKGROUND OF INVENTION

Polymer films are widely used in packaging. These films must obviously protect the contents of the package from damage and the environment.

Polyethylene films are widely used in packaging due to their excellent cost/performance ratios. However, due to increasing demands on the needs of the films, multilayer packaging is typically employed utilising different types of polymers. Whilst these can offer attractive properties, the recycling of such materials is difficult. Therefore, making the materials pure is preferred. In that manner, a packaging with ‘mono-materials’ is really appreciated. However, this imposes higher requirements on the performance of materials themselves.

There is thus a need to produce multilayer films which offer the opportunity for facile recycling, together with an attractive balance of properties, e.g. a multilayered material with balanced sealing, stiffness, toughness is highly desirable.

To resolve that problem a machine direction oriented polyethylene (MDO PE) or biaxially oriented polyethylene (BOPE) film can be used to replace the PET film which is often employed due to its attractive properties. HDPE offers a good alternative to PET in terms of stiffness and thermal resistance. The resulting material comprises polyethylene only and is hence fully mechanically recycled.

WO 2019/108326 describes a multilayer film, comprising a machine direction oriented (MDO) substrate and a sealant, wherein the substrate has at least three layers. The core layer is described to comprise two polyethylenes and at least one of the other layers comprises a third polyethylene.

WO 2018/071250 relates to machine direction oriented polymer films wherein at least one layer comprises an ethylene-based polymer having a particular set of properties.

The present inventors have unexpectedly found that a uniaxially oriented film comprising an outer layer, a core layer and a sealing layer, wherein at least one of those layers comprises a particular class of multimodal polyethylene terpolymers possesses an attractive balance of mechanical, optical and sealing properties.

### SUMMARY OF INVENTION

Viewed from one aspect the invention provides a uniaxially oriented multilayer film comprising at least a sealing layer, a core layer and an outer layer, wherein at least one of said layers comprises a metallocene-catalysed multimodal polyethylene terpolymer having a density in the range of from 910 to 916 kg/m³ and an MFR₂ (190° C., 2.16 kg, ISO 1133) in the range of from 0.1 to 2.5 g/10 min.

Viewed from another aspect, the invention provides an article, preferably a packaging article comprising a uniaxially oriented film as hereinbefore defined.

Viewed from a further aspect, the invention provides the use of a metallocene-catalysed multimodal polyethylene terpolymer having a density in the range of from 910 to 916 kg/m³ and an MFR₂ (190° C., 2.16 kg, ISO 1133) in the range of from 0.1 to 2.5 g/10 min in the production of a uniaxially oriented film as hereinbefore defined.

### DETAILED DESCRIPTION

### Definitions

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

The metallocene catalysed multimodal polyethylene terpolymer is defined in this invention as a multimodal polyethylene terpolymer which has been produced in the presence of a metallocene catalyst.

Term “multimodal” means herein multimodality with respect to melt flow rate (MFR) of the ethylene polymer components as well as the preferable ethylene polymer fractions (A-1) and (A-2), i.e. the ethylene polymer components and/or fractions (A-1) and (A-2) have different MFR values. The multimodal polyethylene terpolymer can have further multimodality with respect to one or more further properties between the ethylene polymer components as well as between fractions (A-1) and (A-2), as will be described later below.

The multimodal polyethylene terpolymer of the invention as defined above, below or in claims is also referred herein shortly as “multimodal PE” or “multimodal terpolymer”.

The following preferable embodiments, properties and subgroups of multimodal PE and the ethylene polymer components (A) and (B) thereof, as well as the preferable ethylene polymer fractions (A-1) and (A-2) and the film of the invention including the preferable ranges thereof, are independently generalisable so that they can be used in any order or combination to further define the preferable embodiments of the multimodal PE and the article of the invention.

### Metallocene-Catalysed Multimodal Polyethylene Terpolymer

It has been found that the multimodal polyethylene terpolymer according to the invention provides an improved material for uniaxially oriented film applications, which combines very good sealing properties and mechanical properties e.g. in terms of tensile modulus, with excellent optical properties e.g. in terms of haze.

The polymer of the invention is a multimodal polyethylene terpolymer. By ethylene terpolymer is meant a polymer the majority by weight of which derives from ethylene monomer units (i.e. at least 50 wt % ethylene relative to the total weight of the copolymer). The comonomer contribution preferably is up to 20% by weight, more preferably in the range 5 to 18 wt %, such as 7 to 15 wt %, relative to the total weight of the copolymer.

The term “terpolymer” will be understood to mean that the polymer contains two comonomers in addition to ethylene. The other copolymerizable monomers are preferably C3-12, especially C3-10, alpha olefin comonomers, particularly singly or multiply ethylenically unsaturated comonomers, in particular C3-10-alpha olefins such as propene, but-1-ene, hex-1-ene, oct-1-ene, and 4-methyl-pent-1-ene. The use of two comonomers selected from the group consisting of 1-hexene, 1-octene and 1-butene, is particularly preferred, especially 1-hexene and 1-butene.

The polymer of the invention is multimodal and therefore comprises at least two components. The polymer is preferably bimodal. The polymer of the invention most preferably comprises
(A) a lower molecular weight ethylene copolymer component, and
(B) a higher molecular weight ethylene copolymer component.

The polyethylene terpolymer of the invention is multimodal. Usually, a polyethylene composition comprising at least two polyethylene fractions, which have been produced under different polymerization conditions resulting in different (weight average) molecular weights and molecular weight distributions for the fractions, is referred to as “multimodal”. Accordingly, in this sense the compositions of the invention are multimodal polyethylenes. The prefix “multi” relates to the number of different polymer fractions the composition is consisting of. The polyethylene may also be multimodal with respect to comonomer content.

The form of the molecular weight distribution curve, i.e. the appearance of the graph of the polymer weight fraction as a function of its molecular weight, of such a multimodal polyethylene will show two or more maxima or at least be distinctly broadened in comparison with the curves for the individual fractions.

For example, if a polymer is produced in a sequential multistage process, utilising reactors coupled in series and using different conditions in each reactor, the polymer fractions produced in the different reactors will each have their own molecular weight distribution and weight average molecular weight. When the molecular weight distribution curve of such a polymer is recorded, the individual curves from these fractions are superimposed into the molecular weight distribution curve for the total resulting polymer product, usually yielding a curve with two or more distinct maxima.

The terpolymer of the invention has an MFR₂ of 0.1 to 2.5 g/10 min. Preferable ranges for MFR₂ are 0.5 to 2.0 g/10 min, such as 0.8 to 1.5 g/10 min.

The terpolymer of the invention preferably has an MFR₂₁ of 15 to 80 g/10 min, such as 20 to 70 g/10 min, most preferably 25 to 60 g/10 min.

The terpolymer of the invention preferably has a Flow Rate Ratio (FRR) of the MFR₂₁/MFR₂ of at least 15.0, like at least 20.0, more preferably at least 25.0 Furthermore, the polymer of the invention preferably has a Flow Rate Ratio (FRR) of the MFR₂₁/MFR₂ of up to 70.0, like up to 55.0, more preferably up to 40.0.

The density of the terpolymer is in the range 910 to 916 kg/m³ determined according to ISO 1183 The terpolymers of the invention are therefore typically considered linear low density polyethylenes (LLDPEs). Preferably, the polymer has a density of 911 to 915 kg/m³ or more, more preferably 912 to 915 kg/m³, such as 913 kg/m³.

The terpolymer of the invention is multimodal and thus comprises at least a lower molecular weight component (A) and a higher molecular weight component (B). In one particularly preferable embodiment, the terpolymer consists of components (A) and (B). The weight ratio of fraction (A) to fraction (B) in the composition is in the range 30:70 to 70:30, more preferably 35:65 to 65:35, most preferably 40:60 to 60:40. In some embodiments the ratio may be 35 to 50 wt % of fraction (A) and 50 to 65 wt % fraction (B), such as 40 to 50 wt % of fraction (A) and 50 to 60 wt % fraction (B), wherein the wt % values are relative to the total weight of the multimodal polyethylene terpolymer.

In a particularly preferred embodiment, the wt % values for fractions (A) and (B) add up to 100%.

Each of Fraction (A) and Fraction (B) is an ethylene copolymer. The term “ethylene copolymer” is defined above.

The lower molecular weight fraction (A) typically has an MFR₂ (190° C., 2.16 kg, ISO 1133) of 2.0 to 300 g/10 min, preferably of 2.0 to 200 g/10 min, more preferably of 2.8 to 150 g/10 min, even more preferably 3.0 to 100 g/10 min, such as 3.2 to 40 g/10 min Fraction (A) generally has a density of 915 to 975 kg/m³, preferably 920 to 960 kg/m³, more preferably 930 to 950 kg/m³, such as 933 to 942 kg/m³.

Fraction (A) is an ethylene copolymer. Preferred ethylene copolymers employ alpha-olefins (e.g. C3-12 alpha-olefins) as comonomers. Examples of suitable alpha-olefins include but-1-ene, hex-1-ene and oct-1-ene. But-1-ene is an especially preferred comonomer.

The higher molecular weight fraction (B) typically has an MFR₂ of 0.001 to 1.5 g/10 min, preferably of 0.01 to 1.5 g/10 min, more preferably of 0.05 to 1.5 g/10 min, even more preferably 0.1 to 1.2 g/10 min, such as 0.2 to 1.0 g/10 min.

Fraction (B) generally has a density of 880 to 910 kg/m³, preferably 885 to 905 kg/m³, such as 890 to 900 kg/m³.

Fraction (B) is a copolymer. Preferred ethylene copolymers employ alpha-olefins (e.g. C3-12 alpha-olefins) as comonomers. Examples of suitable alpha-olefins include but-1-ene, hex-1-ene and oct-1-ene. Hex-1-ene is an especially preferred comonomer.

In a particularly preferred embodiment, the terpolymer of the invention comprises, preferably consists of:
(i) 30.0 to 70.0 wt % of an ethylene-1-butene polymer component (A), and
(ii) 70.0 to 30.0 wt % of an ethylene-1-hexene polymer component (B).

The amount of (A) and (B) preferably add up to 100.0 wt %.

In one embodiment of the present invention, the ethylene-1-butene polymer component (A) consists of an ethylene polymer fraction (A-1) and (A-2). In case that the ethylene-1-butene polymer component (A) consists of ethylene polymer fractions (A-1) and (A-2), the MFR₂ of the ethylene polymer fractions (A-1) and (A-2) may be different from each other.

The ethylene polymer fraction (A-1) typically has a MFR₂ (190° C., 2.16 kg, ISO 1133) in the range of 1.0 to 300 g/10 min, preferably of 1.0 to 200 g/10 min, more preferably of 1.5 to 150 g/10 min, even more preferably of 2.0 to 100 g/10 min and especially preferably of 2.5 to 80 g/10 min, like 3.0 to 40 g/10 min.

The ethylene polymer fraction (A-2) may have a MFR₂ (190° C., 2.16 kg, ISO 1133) in the range of 1.0 to 300 g/10 min, preferably 3.0 to 40.0 g/10 min, more preferably of 3.2 to 30.0 g/10 min, even more preferably of 3.5 to 20.0 g/10 min and most preferably of 3.5 to 10.0 g/10 min.

The MFR₂ of the ethylene polymer components (A) and (B) are different from each other.

The ethylene polymer component (A) preferably has a MFR₂ (190° C., 2.16 kg, ISO 1133) in the range of 2.0 to 300 g/10 min, preferably of 2.0 to 200 g/10 min, more preferably of 2.8 to 150 g/10 min, even more preferably of 3.0 to 100 g/10 min, such as 3.2 to 40 g/10 min.

The ethylene polymer component (B) preferably has a MFR₂ (190° C., 2.16 kg, ISO 1133) in the range of 0.001 to 1.5 g/10 min, preferably 0.01 to 1.5 g/10 min, more preferably of 0.05 to 1.5 g/10 min, even more preferably of 0.1 to 1.2 g/10 min, such as 0.2 to 1.0 g/10 min.

In one embodiment of the invention it is preferred that the ratio of the MFR₂ (190° C., 2.16 kg, ISO 1133) of ethylene-1-butene polymer component (A) to the MFR₂ (190° C., 2.16 kg, ISO 1133) of the final multimodal terpolymer is at least 2.5 to 300, preferably 3.0 to 150 and more preferably of 3.5 to 100.

Naturally, in addition to multimodality with respect to, i.e. the difference between, the MFR₂ of ethylene polymer components (A) and (B), the multimodal PE of the invention can also be multimodal e.g. with respect to one or both of the two further properties:
multimodality with respect to, i.e. difference between,
   the comonomer content(s) present in the ethylene polymer components (A) and (B); and/or
   the density of the ethylene polymer components (A) and (B).

Preferably, the multimodal terpolymer is further multimodal with respect to the comonomer content of the ethylene polymer components (A) and (B).

The comonomer content of component (A) and (B) can be measured, or, in case, and preferably, one of the components is produced first and the other thereafter in the presence of the first produced in so called multistage process, then the comonomer content of the first produced component, e.g. component (A), can be measured and the comonomer content of the other component, e.g. component (B), can be calculated according to following formula:

Comonomer content (wt %) in component B=(comonomer content (wt %) in final product−(weight fraction of component A*comonomer content (wt %) in component A))/(weight fraction of component B)

The total amount of 1-butene, based on the multimodal terpolymer is preferably in the range of from 0.1 to 4.0 wt %, more preferably from 0.1 to 1.0 wt %, even more preferably 0.2 to 0.8 wt %, such as 0.3 to 0.6 wt %.

The total amount of 1-hexene, based on the multimodal terpolymer preferably is in the range of 2.0 to 20.0 wt %, preferably 4.0 to 18.0 wt % and more preferably 6.0 to 15.0 wt %.

The total amount (wt %) of 1-butene, present in the ethylene-1-butene polymer component (A) is typically 0.1 to 10 wt %, preferably 0.5 to 5.0 wt %, more preferably of 0.8 to 4.0 wt %, even more preferably of 1.0 to 3.0 wt %, such as 1.0 to 2.0 wt %, based on the ethylene-1-butene polymer component (A).

The total amount (wt %) of 1-hexene, present in the ethylene-1-hexene polymer component (B) is typically 15.0 to 25.0 wt %, preferably of 16.0 to 22.0 wt %, more preferably of 17.0 to 20.0 wt %, based on the ethylene-1-hexene polymer component (B).

Even more preferably the multimodal terpolymer of the invention is further multimodal with respect to difference in density between the ethylene copolymer component (A) and ethylene copolymer component (B). Preferably, the density of ethylene copolymer component (A) is different, preferably higher, than the density of the ethylene copolymer component (B).

The density of the ethylene copolymer component (A) is generally in the range of 915 to 975 kg/m³, preferably 920 to 960 kg/m³, more preferably 930 to 950 kg/m³, such as 933 to 942 kg/m³ and/or the density of the ethylene polymer component (B) is generally in the range of 880 to 910 kg/m³, preferably 885 to 905 kg/m³, such as 890 to 900 kg/m³.

The polymer fraction (A-1) typically has a density in the range of from 920 to 960 kg/m³, preferably of 925 to 955 kg/m³, more preferably of 930 to 950 kg/m³, like 935 to 945 kg/m³.

The density of the polymer fraction (A-2) is preferably in the range of from 930 to 950 kg/m³, more preferably of 935 to 945 kg/m³.

It is within the scope of the invention, that the first and the second ethylene polymer fraction (A-1 and A-2) of the ethylene polymer component (A) may be present in a weight ratio of 4:1 up to 1:4, such as 3:1 to 1:3, or 2:1 to 1:2, or 1:1.

The ethylene polymer component (A) is present in an amount of 30.0 to 70.0 wt % based on the multimodal terpolymer, preferably in an amount of 32.0 to 55.0 wt % and even more preferably in an amount of 34.0 to 45.0 wt %.

Thus, the ethylene polymer component (B) is present in an amount of 70.0 to 30.0 wt % based on the multimodal terpolymer, preferably in an amount of 68.0 to 45.0 wt % and more preferably in an amount of 66.0 to 55.0 wt %.

### Preparation of the Metallocene Catalysed Multimodal Ethylene Terpolymer

The metallocene catalysed multimodal terpolymer can be produced in a 2-stage process, preferably comprising a slurry reactor (loop reactor), whereby the slurry (loop) reactor is connected in series to a gas phase reactor (GPR), whereby the low molecular weight polymer component is produced in the loop reactor and the high molecular weight polymer component is produced in GPR in the presence of the low molecular weight polymer component to produce the multimodal terpolymer.

In case that the ethylene component (A) of the multimodal terpolymer consists of ethylene polymer fractions (A-1) and (A-2), the multimodal terpolymer can be produced with a 3-stage process, preferably comprising a first slurry reactor (loop reactor 1), whereby the first slurry loop reactor is connected in series with another slurry reactor (loop reactor 2), so that the first ethylene polymer fraction (A-1) produced in the loop reactor 1 is fed to the loop reactor 2, wherein the second ethylene polymer fraction (A-2) is produced in the presence of the first fraction (A-1). The loop reactor 2 is thereby connected in series to a gas phase reactor (GPR), so that the first ethylene copolymer component (A) leaving the second slurry reactor is fed to the GPR to produce a trimodal polyethylene copolymer. In this case, the reaction conditions in the two slurry reactors are chosen in a way that in the two slurry reactors different products in view of MFR and/or density are produced.

Such a process is described inter alia in WO 2016/198273, WO 2021009189, WO 2021009190, WO 2021009191 and WO 2021009192. Full details of how to prepare suitable metallocene catalysed multimodal copolymer can be found in these references.

A suitable process is the Borstar PE process or the Borstar PE 3G process.

The metallocene catalysed multimodal terpolymer according to the present invention is therefore preferably produced in a loop loop gas cascade. Such polymerization steps may be preceded by a prepolymerization step. The purpose of the prepolymerization is to polymerize a small amount of polymer onto the catalyst at a low temperature and/or a low monomer concentration. By prepolymerization it is possible to improve the performance of the catalyst in slurry and/or modify the properties of the final polymer. The prepolymerization step is preferably conducted in slurry and the amount of polymer produced in an optional prepolymerization step is counted to the amount (wt %) of ethylene polymer component (A).

The catalyst components are preferably all introduced to the prepolymerization step when a prepolymerization step is present. However, where the solid catalyst component and the cocatalyst can be fed separately it is possible that only a part of the cocatalyst is introduced into the prepolymerization stage and the remaining part into subsequent polymerization stages. Also in such cases it is necessary to introduce so much cocatalyst into the prepolymerization stage that a sufficient polymerization reaction is obtained therein.

It is understood within the scope of the invention, that the amount or polymer produced in the prepolymerization lies within 1 to 5 wt % in respect to the final metallocene catalysed multimodal terpolymer. This can be counted as part of the first ethylene copolymer component (A).

### Catalyst

The metallocene catalysed multimodal terpolymer of the invention is one made using a metallocene catalyst. A metallocene catalyst comprises a metallocene complex and a cocatalyst. The metallocene compound or complex is referred herein also as organometallic compound (C).

The organometallic compound (C) comprises a transition metal (M) of Group 3 to 10 of the Periodic Table (IUPAC 2007) or of an actinide or lanthanide.

The term “an organometallic compound (C)” in accordance with the present invention includes any metallocene or non-metallocene compound of a transition metal, which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

In an embodiment, the organometallic compound (C) has the following formula (I):

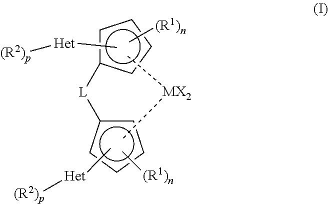

wherein each X is independently a halogen atom, a C₁₋₆-alkyl group, C₁₋₆-alkoxy group, phenyl or benzyl group;
each Het is independently a monocyclic heteroaromatic group containing at least one heteroatom selected from O or S;
L is —R¹₂Si—, wherein each R¹ is independently C₁₋₂₀-hydrocarbyl or C₁₋₁₀-alkyl substituted with alkoxy having 1 to 10 carbon atoms;
M is Ti, Zr or Hf;
each R¹ is the same or different and is a C₁₋₆-alkyl group or C₁₋₆-alkoxy group;
each n is 1 to 2;
each R² is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

Preferably, the compound of formula (I) has the structure

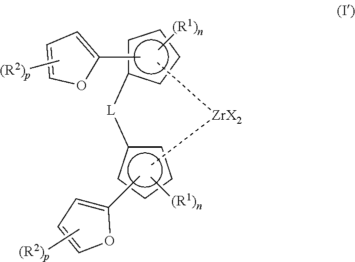

wherein each X is independently a halogen atom, a C₁₋₆-alkyl group, C₁₋₆-alkoxy group, phenyl or benzyl group;
L is a Me₂Si—;
each R¹ is the same or different and is a C₁₋₆-alkyl group, e.g. methyl or t-Bu;
each n is 1 to 2;
R² is a —Si(R)₃ alkyl group; each p is 1;
each R is C₁₋₆-alkyl or phenyl group.

Highly preferred complexes of formula (I) are

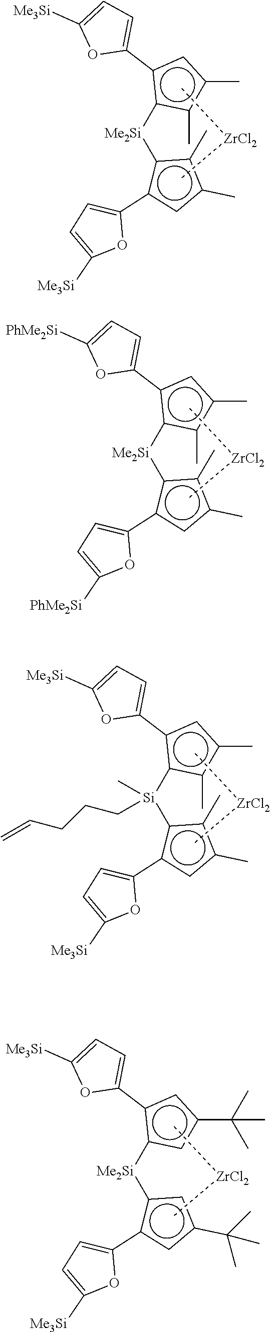

Most preferably the complex dimethylsilanediylbis[2-(5-trimethylsilylfuran-2-yl)-4,5-dimethylcyclopentadien-1-yl]zirconium dichloride is used.

More preferably the high and low molecular weight components of the multimodal terpolymer are produced using, i.e. in the presence of, the same metallocene catalyst.

To form a catalyst, a cocatalyst, also known as an activator, is used, as is well known in the art. Cocatalysts comprising Al or B are well known and can be used here. The use of aluminoxanes (e.g. MAO) or boron based cocatalysts (such as borates) is preferred.

Polyethylene copolymers made using single site catalysis, as opposed to Ziegler Natta catalysis, have characteristic features that allow them to be distinguished from Ziegler Natta materials. In particular, the comonomer distribution is more homogeneous. This can be shown using TREF or Crystaf techniques. Catalyst residues may also indicate the catalyst used. Ziegler Natta catalysts would not contain a Zr or Hf group (IV) metal for example.

The metallocene catalysed multimodal ethylene terpolymer may contain further polymer components and optionally additives and/or fillers. In case the metallocene catalysed multimodal terpolymer contains further polymer components, then the amount of the further polymer component(s) typically varies between 3.0 to 20.0 wt % based on the combined amount of the metallocene catalysed multimodal terpolymer and the other polymer component(s).

The optional additives and fillers and the used amounts thereof are conventional in the field of film applications. Examples of such additives are, among others, antioxidants, process stabilizers, UV-stabilizers, pigments, fillers, antistatic additives, antiblock agents, nucleating agents, acid scavengers as well as polymer processing agent (PPA).

It is understood herein that any of the additives and/or fillers can optionally be added in so-called master batch, which comprises the respective additive(s) together with a carrier polymer. In such case the carrier polymer is not calculated to the polymer components of the metallocene catalysed multimodal terpolymer, but to the amount of the respective additive(s), based on the total amount of polymer composition (100 wt %).

### Film

The film of the invention is a uniaxially oriented film. Preferably, the film is oriented in the machine direction. The uniaxially oriented films of the present invention can have a thickness in the range of 5.0-100 μm, such as 10.0-75.0 μm, like 15.0-50 μm or 20.0-40.0 μm.

The uniaxially oriented films of the present invention show good optical properties in view of haze transparency when measured according to ASTM D1003. The haze is typically 12.0% or lower such as 11.0 or 10.0% or lower. The haze may be in the range of 2.0 to 12.0, preferably 5.0 to 11.0, more preferably 7.0 to 10.0. The measurements for haze are done 20 μm films.

Further, it is preferred that the film has a tensile modulus (TM) determined according to ISO 527-3 on 20 μm films in machine direction (MD) of at 800 MPa to 4000 MPa, more preferably in the range of 1100 to 3000 MPa, still more preferably in the range of 1200 to 2000 MPa.

The uniaxially oriented film preferably have a seal initiation temperature (SIT) of less than 115° C., more preferably less than 110° C. Ideally, the SIT will be at least 80° C., preferably at least 90° C.

The multilayer films of the invention comprise at least a sealing layer, a core layer and an outer layer, wherein at least one of said layers comprises the metallocene-catalysed multimodal polyethylene terpolymer as hereinbefore described. Thus, the films of the invention comprise at least three layers, however it is possible for the films to comprise more than three layers, such as 4 or 5 layers. Where more than three layers are present, the additional layers are typically tie layers.

Preferably, the metallocene-catalysed multimodal polyethylene terpolymer forms the sealing layer. In one embodiment of the invention, the sealing layer consists essentially of the multimodal terpolymer. The term consists essentially of means that the polymer of the invention is the only “non additive” polyolefin present. It will be appreciated however that such a polymer may contain standard polymer additives some of which might be supported on a polyolefin (a so called masterbatch as is well known in the art). The term consists essentially of does not exclude the presence of such a supported additive.

It is preferred if the sealing layer of the multilayer film of the present invention comprises between 1.0 and 100 wt % of the multimodal terpolymer. In a preferred alternative, the sealing layer film may comprise at least 30.0, or at least 50.0 wt % or at least 70.0 wt % of the multimodal terpolymer. It is further preferred that such layers comprise the multimodal terpolymer in ranges of 30.0-99.0 wt %, such as 50.0-98.0 or 70.0-90.0 wt %, relative to the total weight of the layer.

The outer layer of the multilayer film of the invention preferably comprises a polyethylene having a density of 945 to 975 kg/m³ and an MFR₂ (190° C., 2.16 kg, ISO 1133) in the range of from 0.1 to 4.0 g/10 min. The polyethylene in the outer layer may therefore be considered a high density polyethylene (HDPE) and may be a homopolymer or a copolymer, but is preferably an ethylene copolymer.

The other copolymerizable monomer or monomers are preferably C3-12, especially C3-10, alpha olefin comonomers, particularly singly or multiply ethylenically unsaturated comonomers, in particular C3-10-alpha olefins such as propene, but-1-ene, hex-1-ene, oct-1-ene, and 4-methyl-pent-1-ene. The use of 1-hexene, 1-octene and 1-butene, or mixtures thereof, is particularly preferred, especially 1-hexene and 1-butene. Ideally there is only one comonomer present.

The polyethylene in the outer layer may be unimodal or multimodal. Ideally, it is multimodal, therefore comprising at least two components. It is preferably bimodal. The polyethylene in the outer layer most preferably comprises
(A) a lower molecular weight ethylene homopolymer component, and
(B) a higher molecular weight ethylene copolymer component.

The polyethylene in the outer layer typically has an MFR₂ of 0.2 to 4.0 g/10 min. Preferable ranges for MFR₂ are 0.3 to 2.5 g/10 min, such as 0.5 to 1.5 g/10 min.

The density of the polyethylene in the outer layer is typically in the range 945 to 975 kg/m³. Preferably, the HDPE has a density of 950 to 965 kg/m³, more preferably 953 to 963 kg/m³, such as 954 to 960 kg/m³.

The polyethylene in the outer layer may have a molecular weight distribution (MWD) in the range 5 to 25, preferably 7 to 30, such as 10 to 20.

The polyethylene in the outer layer may be prepared in the presence of any suitable polymerisation catalyst(s), such as a Ziegler-Natta or metallocene catalyst.

The core layer of the multilayer film of the invention preferably comprises a polyethylene having a density of 925 to 945 kg/m³ and an MFR₅ (190° C., 2.16 kg, ISO 1133) in the range of from 0.1 to 2.5 g/10 min.

The polyethylene in the core layer typically has an MFR₅ of 0.1 to 1.5 g/10 min. Preferable ranges for MFR₅ are 0.2 to 1.2 g/10 min, such as 0.5 to 1.0 g/10 min.

The density of the polyethylene in the core layer is typically in the range 925 to 945 kg/m³. Preferably, the polyethylene has a density of 927 to 941 kg/m³, more preferably 929 to 937 kg/m³, even more preferably 929 to 933 kg/m³.

In one embodiment, the core layer (C) comprises a bimodal ethylene/1-butene/C₆-C₁₂-alpha-olefin terpolymer.

Suitable terpolymers can comprise
(A-1) a low molecular weight homopolymer of ethylene and
(A-2) a high molecular weight terpolymer of ethylene, 1-butene and a C₆-C₁₂-alpha-olefin or
(B-1) a low molecular weight copolymer of ethylene and 1-butene or a C₆-C₁₂-alpha olefin and
(B-2) a high molecular weight copolymer of ethylene and 1-butene, if the low molecular weight polymer of (B-1) is a copolymer of ethylene and a C₆-C₁₂-alpha olefin, or a terpolymer of ethylene, 1-butene and a C₆-C₁₂-alpha olefin.

Thus, the polymer comprises a high molecular weight component which corresponds to an ethylene terpolymer of higher alpha-olefin comonomers and a low molecular weight component which corresponds to an ethylene homopolymer or a low molecular weight component which corresponds to an ethylene copolymer and a high molecular weight ethylene-butene copolymer, if the low molecular weight polymer is a copolymer of ethylene and a C₆-C₁₂-alpha-olefin, or a terpolymer.

Preferably the higher alpha-olefin comonomers are C₆-C₁₂-alpha-olefins selected from the group of 1-hexene, 4-methyl-1-pentene, 1-octene and 1-decene.

More preferably the polyethylene in the core layer is formed from an ethylene homopolymer and an ethylene butene/hexene terpolymer Such bimodal polymers may be prepared for example by two stage polymerization or by the use of two different polymerization catalysts in a one stage polymerization. It is also possible to employ a dualsite catalyst. It is important to ensure that the higher and lower molecular weight components are intimately mixed prior to extrusion to form a film. This is most advantageously achieved by using a multistage process or a dual site but could be achieved through blending.

To maximise homogeneity, particularly when a blend is employed, it is preferred if the multimodal polyethylene used in the core layer is extruded prior to being extruded to form the film of the invention. This pre-extrusion step ensures that the higher molecular weight component will be homogeneously distributed though the core layer and minimises the possibility of gel formation in the film.

Preferably the multimodal polyethylene is produced in a multi-stage polymerization using the same catalyst, e.g. a metallocene catalyst or preferably a Ziegler-Natta catalyst. Thus, two slurry reactors or two gas phase reactors could be employed. Preferably however, the multimodal polyethylene is made using a slurry polymerization in a loop reactor followed by a gas phase polymerization in a gas phase reactor.

A loop reactor—gas phase reactor system is marketed by Borealis A/S, Denmark as a BORSTAR reactor system. The multimodal polyethylene in the core layer is thus preferably formed in a two stage process comprising a first slurry loop polymerization followed by gas phase polymerization in the presence of a Ziegler-Natta catalyst.

The conditions used in such a process are well known. For slurry reactors, the reaction temperature will generally be in the range 60 to 110° C. (e.g. 85-110° C.), the reactor pressure will generally be in the range 5 to 80 bar (e.g. 50-65 bar), and the residence time will generally be in the range 0.3 to 5 hours (e.g. 0.5 to 2 hours). The diluent used will generally be an aliphatic hydrocarbon having a boiling point in the range −70 to +100° C. In such reactors, polymerization may if desired be effected under supercritical conditions. Slurry polymerization may also be carried out in bulk where the reaction medium is formed from the monomer being polymerized.

For gas phase reactors, the reaction temperature used will generally be in the range 60 to 115° C. (e.g. 70 to 110° C.), the reactor pressure will generally be in the range 10 to 25 bar, and the residence time will generally be 1 to 8 hours. The gas used will commonly be a non-reactive gas such as nitrogen or low boiling point hydrocarbons such as propane together with monomer (e.g. ethylene).

Preferably, the low molecular weight polymer fraction is produced in a continuously operating loop reactor where ethylene is polymerized in the presence of a polymerization catalyst as stated above and a chain transfer agent such as hydrogen. The diluent is typically an inert aliphatic hydrocarbon, preferably isobutane or propane.

The high molecular weight component can then be formed in a gas phase reactor using the same catalyst.

The bimodal terpolymer comprises in one embodiment a low molecular weight fraction (LMW) of a homopolymer of ethylene and a high molecular weight fraction (HMW) of a terpolymer of ethylene, 1-butene and a C₆-C₁₂-alpha-olefin and in another embodiment a low molecular weight fraction (LMW) of a copolymer of ethylene and 1-butene or a C₆-C₁₂-alpha-olefin, and a high molecular weight fraction which is a copolymer of ethylene and 1-butene, if the low molecular weight polymer is a copolymer of ethylene and a C₆-C₁₂-alpha olefin, or a terpolymer of ethylene, 1-butene and a C₆-C₁₂-alpha-olefin.

The expression “homopolymer of ethylene” used herein refers to a polyethylene that consists substantially, i. e. to at least 98% by weight, preferably at least 99% by weight, more preferably at least 99.5% by weight, most preferably at least 99.8% by weight of ethylene.

As stated above the higher alpha-olefin comonomers are preferably C₆-C₁₂-alpha-olefins selected from the group of 1-hexene, 4-methyl-1-pentene, 1-octene and 1-decene.

More preferably 1-hexene or 1-octene, most preferably 1-hexene is used as second comonomer beside 1-butene.

Such bimodal terpolymers are known in the state of the art and are described e.g. in WO 03/066698 or WO 2008/034630.

Thus suitable terpolymers for the core layer can comprise:
a) in a first embodiment a low molecular weight fraction (LMW) of a homopolymer of ethylene or a binary copolymer of ethylene and a 1-butene or a C₆-C₁₂-alpha-olefin and a high molecular weight fraction (HMW) of a binary copolymer of ethylene and 1-butene, if the low molecular weight polymer of a) is a binary copolymer of ethylene and a C₆-C₁₂-alpha-olefin, or a terpolymer of ethylene, 1-butene and a C₆-C₁₂-alpha-olefin.

Preferably the bimodal terpolymer according to this first embodiment comprises:

A low molecular weight fraction (LMW) of a homopolymer of ethylene or a binary copolymer of ethylene and a 1-butene and a high molecular weight fraction (HMW) of a terpolymer of ethylene, 1-butene and a C₆-C₁₂-alpha-olefin.

The weight average molecular weight of such a bimodal terpolymer according to the first embodiment is preferably between 80 000 to 400 000 g/mol, more preferably between 100 000 to 300 000 g/mol. The low molecular weight polymer fraction has a weight average molecular weight preferably of 4 500 to 55 000 g/mol, more preferably of 5 000 to 50 000 g/mol and the high molecular weight polymer has a weight average molecular weight preferably of 150 000 to 1 000 000 g/mol, more preferably of 200 000 to 800 000 g/mol.

The molecular weight distribution of the polymer is further characterized by the way of its melt flow rate (MFR) according to ISO 1133 at 190° C. The melt flow rate is preliminary depending on the mean molecular weight. This is, because long, well-packed molecules give the material a lower flow tendency than short, less-packed molecules.

An increase in molecular weight means a decrease in MFR value. The melt flow rate is measured in g/10 min of the polymer discharge under a specified temperature and pressure condition and is a measure of the viscosity of the polymer, which in turn for each type of polymer is mainly influenced by its molecular weight distribution, but also by its degree of branching etc. The melt flow rate measured under a load 2.16 kg (ISO 1133) is denoted as MFR₂. In turn, the melt flow rate measured with 21.6 kg is denoted as MFR₂₁.

The final bimodal terpolymer according to the first embodiment has a melt flow rate MFR₂₁, preferably of 7 to 60 g/10 min, more preferably of 10 to 50 g/10 min and most preferably 15 to 45 g/10 min.

The low molecular weight polymer has a melt index MFR₂, preferably of 200 to 800 g/10 min, more preferably of 300 to 600 g/10 min.

The density of the final bimodal terpolymer according to the first embodiment is typically 925 to 945 kg/m³. Preferably, the polyethylene has a density of 927 to 941 kg/m³, more preferably 929 to 937 kg/m³, even more preferably 929 to 933 kg/m³.

The density of the low molecular weight polymer is preferably 940 to 980 kg/m³, more preferably 945 to 975 kg/m³.

The amount of the low molecular weight copolymer in the bimodal terpolymer is in the range of 30 to 60 wt %, preferably 35 to 50 wt % and most preferably 38 to 45 wt %.

The overall comonomer content in the bimodal terpolymer according to the first embodiment is 1 to 7% by weight, preferably 2 to 6% by weight and in the low molecular weight polymer the comonomer content is 0 to 2.5% by weight, preferably 0 to 2% by weight. In the high molecular weight polymer is the comonomer content 2.5 to 11% by weight, preferably 3 to 10% by weight.

Further, the molecular weight of the high molecular weight copolymer fraction should be such that when the low molecular weight copolymer fraction has the melt index and density specified above, the final bimodal terpolymer has the melt index and density as discussed above.
b) in a second embodiment a low molecular weight homopolymer of ethylene and a high molecular weight terpolymer of ethylene, 1-butene and a C₆-C₁₂-alpha-olefin.

The weight average molecular weight of the bimodal terpolymer according to the second embodiment is between 100 000 to 500 000 g/mol, preferably 200 000 to 400 000 g/mol. The low molecular weight polymer fraction has a weight average molecular weight preferably of 4 500 to 55 000 g/mol, more preferably of 5 000 to 50 000 g/mol and the high molecular weight polymer has a weight average molecular weight preferably of 200 000 to 1 000 000 g/mol, more preferably of 300 000 to 800 000 g/mol.

The final bimodal terpolymer according to the second embodiment has a melt flow rate MFR₂₁, preferably of 2 to 35 g/10 min, more preferably of 3 to 30 g/10 min. The low molecular weight polymer has a melt index MFR₂ preferably of 300 to 1 200 g/10 min, more preferably of 300 to 600 g/10 min.

The density of the final bimodal terpolymer according to the second embodiment is preferably of 935 to 970 kg/m³, more preferably of 940 to 965 kg/m³. The density of the low molecular weight polymer is preferably of 970 to 980 kg/m³, more preferably of 972 to 978 kg/m³, most preferably 975 kg/m³.

The amount of the low molecular weight copolymer in the bimodal terpolymer according is in the range of 30 to 60 wt %, more preferably 35 to 50 wt % and most preferably 38 to 45 wt %.

The overall comonomer content in the total polymer is 0.3 to 3.0% by weight, preferably 0.5 to 2.5% by weight and in the high molecular weight polymer is the comonomer content 0.5 to 3.5% by weight, preferably 0.7 to 3.0% by weight.

Further, the molecular weight of the high molecular weight copolymer fraction should be such that when the low molecular weight copolymer fraction has the melt index and density specified above, the final bimodal terpolymer has the melt index and density as discussed above.
c) in a third embodiment a low molecular weight fraction (LMW) of a binary copolymer of ethylene and a 1-butene or a C₆-C₁₂ alpha-olefin and a high molecular weight fraction (HMW) of a binary copolymer of ethylene and 1-butene if the low molecular weight polymer is a binary copolymer of ethylene and a C₆-C₁₂ alpha-olefin, or a terpolymer of ethylene, 1-butene and a C₆-C₁₂ alpha-olefin.

The weight average molecular weight of the bimodal terpolymer according to the third embodiment is between 110 000 to 210 000 g/mol, preferably 120 000 to 200 000 g/mol. The low molecular weight polymer fraction has a weight average molecular weight preferably of 25 000 to 110 000 g/mol, more preferably of 30 000 to 100 000 g/mol and the high molecular weight polymer has a weight average molecular weight preferably of 100 000 to 400 000 g/mol, more preferably of 150 000 to 370 000 g/mol.

The final bimodal terpolymer according to the third embodiment has a melt flow rate MFR₂₁ preferably of 15 to 80 g/10 min, more preferably of 20 to 70 g/10 min. The low molecular weight polymer has a melt index MFR₂ preferably of 1 to 50 g/10 min, more preferably of 2 to 20 g/10 min.

The density of the final bimodal terpolymer according to the third embodiment is preferably of 900 to 935 kg/m³, more preferably of 915 to 930 kg/m3 and in particular 920 to 925 kg/m³. The density of the low molecular weight polymer is preferably of 925 to 950 kg/m³, more preferably of 930 to 940 kg/m³.

The amount of the low molecular weight copolymer in the bimodal terpolymer according to the third embodiment is in the range of 30 to 60 wt %, more preferably 35 to 50 wt % and most preferably 38 to 45 wt %.

The overall comonomer content in the total polymer according to the third embodiment is 1 to 7% by weight, preferably 2 to 6% by weight and in the low molecular weight polymer is the comonomer content 0.5 to 3.5% by weight, preferably 1 to 3% by weight. In the high molecular weight polymer is the comonomer content 3.5 to 10.5% by weight, preferably 4 to 10% by weight.

Further, the molecular weight of the high molecular weight copolymer fraction should be such that when the low molecular weight copolymer fraction has the melt index and density specified above, the final bimodal terpolymer has the melt index and density as discussed above.

In an alternative embodiment, the core layer may comprise a trimodal ethylene polymer comprising:
i) 10 to 30 wt % of a first ethylene homopolymer (PE1);
ii) 15 to 35 wt % a second ethylene homopolymer (PE2) having an MFR₂ which is at least 50 g/10 min higher than the MFR₂ of component i); and
iii) 45 to 65 wt % of a third ethylene copolymer with at least one alpha-olefin comonomer (PE3).

The α-olefin in PE3 is preferably an α-olefin of 4 to 8 carbon atoms or mixtures thereof. In particular 1-butene, 1-hexene and 1-octene and their mixtures are the preferred α-olefins, especially preferred 1-butene and 1-hexene.

If present, any additional tie layers may comprise a polyethylene as hereinbefore defined for the core layer, or a mixture of more than one polyethylene as defined for the core layer, or a mixture of a polyethylene as defined for the core layer and a polyethylene as defined for the outer layer.

If other polymers other than those described above are present in any layer, it is preferred if any other polymer is a polyethylene. Thus, in a preferred embodiment, the uniaxially oriented films of the present invention are characterised by being free of any polymers other than polyethylenes. Suitable polyethylenes that can be mixed include HDPE, MDPE, LLDPE, LDPE and ethylene based plastomers and elastomers.

The uniaxially oriented films of the present invention may contain usual polymer additives, such as slip agents, UV-stabilisers, pigments, antioxidants, nucleating agents and so on. These additives may be carried on a carrier polymer in the form of a masterbatch.

For the avoidance of doubt, it is envisaged that usual polymer additives, e.g. as described above may be present even when each film layer “consists” of a particular polymer as defined above. The term “consists of” is not intended therefore to exclude the presence of polymer additives. It does however exclude the presence of other polymer components for blending. If a carrier polymer is used as part of a masterbatch, that is not excluded however. Articles may be free of any other mixing polymers but may still comprise minor amounts of carrier polymer used for masterbatches.

The outer layer, sealing layer and core layer may all be of equal thickness or alternatively the core layer may be thicker than each of the sealing layer and outer layer. A convenient film comprises a sealing layer and an outer layer which each form 10 to 35%, preferably 15 to 30% of the total thickness of the 3-layered film, the core layer forming the remaining thickness, e.g. 30 to 80%, preferably 40 to 70% of the total thickness of the 3-layered film. The multilayer films of the present invention can be symmetric (with the outer layer and the sealing layer having the same thickness, or asymmetric (with the outer layer and the sealing layer differing in view of their thickness.

The three-layer structure in accordance with the present invention may be prepared by any conventional film extrusion procedure known in the art including cast film and blown film extrusion. Preferably, the three-layer film is formed by blown film extrusion, more preferably by coextrusion processes, which in principle are known and available to the skilled person.

Typical processes for preparing a three-layer structure in accordance with the present invention are extrusion processes through an angular die, followed by blowing into a tubular film by forming a bubble which is collapsed between the rollers after solidification. This film can then be slid, cut or converted, such as by using a gazette head, as desired. Conventional film production techniques may be used in this regard. Typically the core layer mixture and the mixture for the sandwiching layers are coextruded at a temperature in the range of from 160 to 240° C. and cooled by blowing gas (generally air) at a temperature of 10 to 50° C., to provide a frost line height of 1 or 2 to 8 times the diameter of the dye. The blow up ratio should generally be in the range of from 1.5 to 4, such as from 2 to 4, preferably 2.5 to 3.

If desired any of the three layers of the three-layered structure of the invention may comprise usual additives, such as stabilizers, processing aids, colorants, anti-block agents, slip agents etc. in amounts not detrimental to the desired function of the three-layered structure. Typically the overall amount of additives in a layer is 7 wt % or less, based on the weight of the layer, preferably 5 wt % or less, more preferably 3 wt % or less. In embodiments the layers can be completely free of any additives.

The three-layer structure as identified in the present invention surprisingly displays an excellent balance of processability and stiffness in combination with improved toughness.

The multilayer films of the invention are preferably asymmetric, i.e. wherein the outer layer and sealing layers are different.

The preparation process of the uniaxially oriented multilayer film of the invention comprises at least the steps of forming a layered film structure and stretching the obtained multilayer film in the machine direction, typically in a draw ratio of at least 1:3. As to the first step of the preparation process, the layered structure of the film of the invention may be prepared by any conventional film formation process including extrusion procedures, such as cast film or blown film extrusion. The multilayer films are ideally blown films and are thus preferably prepared by blown film extrusion.

Particularly preferably the multilayer film of the invention is formed by blown film extrusion, more preferably by blown film coextrusion processes. Typically, the compositions providing the core, sealing and outer layers will be blown (co)extruded at a temperature in the range 160° C. to 240° C., and cooled by blowing gas (generally air) at a temperature of 10 to 50° C. to provide a frost line height of 1 or 2 to 8 times the diameter of the die. The blow up ratio should generally be in the range 1.2 to 6, preferably 1.5 to 4.

The obtained, preferably coextruded, multilayer film is subjected to a subsequent stretching step, wherein the multilayer film is stretched in the machine direction. Stretching may be carried out by any conventional technique using any conventional stretching devices which are well known to those skilled in the art. E.g. the film may be coextruded to first form a bubble which is then collapsed and cooled, if necessary, and the obtained tubular film is stretched in line. Stretching is preferably carried out at a temperature in the range 70-90° C., e.g. about 80° C. Any conventional stretching rate may be used, e.g. 2 to 40%/second.

Preferably, the film is stretched only in the MD. The effect of stretching in only one direction is to uniaxially orient the film. The film is stretched at least 3 times, preferably 3 to 10 times, its original length in the machine direction. This is stated herein as a draw ratio of at least 1:3, i.e. “1” represents the original length of the film and “3” denotes that it has been stretched to 3 times that original length. Preferred films of the invention are stretched in a draw ratio of at least 1:4, more preferably between 1:5 and 1:8, e.g. between 1:5 and 1:7. An effect of stretching (or drawing) is that the thickness of the film is similarly reduced. Thus a draw ratio of at least 1:3 preferably also means that the thickness of the film is at least three times less than the original thickness. Blow extrusion and stretching techniques are well known in the art, e.g. in EP-A-299750.

The film preparation process steps of the invention are known and may be carried out in one film line in a manner known in the art. Such film lines are commercially available. The final uniaxially oriented in MD films can be further processed, e.g. laminated on a substrate. Preferably, however, the films are used in non-laminated film applications.

The films of the invention have a wide variety of applications but are of particular interest in packaging.

Thus, viewed from another aspect, the invention provides an article, preferably a packaging article, comprising a uniaxially oriented multilayer film as hereinbefore defined.

The additional optional layers are naturally selected so that they have no adverse effect on the inventive effect achieved with the three-layer structure according to the invention. Thus it is also possible to use the three-layer structure of the present invention for producing a 5- or even 7-layered film, depending upon the desired end application.

However, the three-layer structure in accordance with the present invention preferably is employed as such, without lamination to any further film material.

The uniaxially oriented films of the present invention may be used for the production of packaging articles like bags, pouches, labels or lids, or other technical applications like banknotes. The uniaxially oriented films of the present invention are preferably used for applications related to food packaging.

The present invention will now be described in further detail by the examples provided below:

The following definitions of terms and determination methods apply for the above general description of the invention as well as to the below examples unless otherwise defined.

### Determination Methods

### Melt Flow Rate (MFR)

The melt flow rates were measured at 190° C. with a load of 2.16 kg (MFR₂) or 5.0 kg (MFR₅) or 21.6 kg (MFR₂₁) according to ISO 1133

### Calculation of MFR₂ of Fractions (A) and (B)

$$log A = x \cdot log B + ( 1 - x ) \cdot log C \\ C = 10 {\hat{}}^{\frac{( logA - x . logB )}{( 1 - x )}}$$

B=MFR₂ of Fraction (A)
C=MFR₂ of Fraction (B)
A=final MFR₂ (mixture) of multimodal polyethylene copolymer (P)
X=weight fraction of Fraction (A)

### Flow Rate Ratio (FRR21/2))

FRR is determined as the ratio between the MFR₂₁ and the MFR₂.

### GPC

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) according to ISO 16014-1:2003, ISO 16014-2:2003, ISO 16014-4:2003 and ASTM D 6474-12 using the following formulas:

$${M}_{n} = \frac{{\sum }_{i = 1}^{N} {A}_{i}}{{\sum }_{i = 1}^{N} ( {A}_{i} / {M}_{i} )} \qquad ( 1 )$$

$${M}_{w} = \frac{{\sum }_{i = 1}^{N} ( {A}_{i} \times {M}_{i} )}{{\sum }_{i = 1}^{N} {A}_{i}} \qquad ( 2 )$$

$${M}_{z} = \frac{{\sum }_{i = 1}^{N} ( {A}_{i} \times {M}_{i}^{2} )}{{\sum }_{i = 1}^{N} ( {A}_{i} \times {M}_{i} )} \qquad ( 3 )$$

For a constant elution volume interval ΔVᵢ, where Aᵢ, and Mᵢ are the chromatographic peak slice area and polyolefin molecular weight (MW), respectively associated with the elution volume, Vᵢ, where N is equal to the number of data points obtained from the chromatogram between the integration limits.

A high temperature GPC instrument, equipped with either infrared (IR) detector (IR4 or IR5 from PolymerChar (Valencia, Spain), equipped with 3×Agilent-PLgel Olexis and 1× Agilent-PLgel Olexis Guard columns was used. As the solvent and mobile phase 1,2,4-trichlorobenzene (TCB) stabilized with 250 mg/L 2,6-Di tert butyl-4-methyl-phenol) was used. The chromatographic system was operated at 160° C. and at a constant flow rate of 1 mL/min. 200 L of sample solution was injected per analysis. Data collection was performed using either Agilent Cirrus software version 3.3 or PolymerChar GPC-IR control software.

The column set was calibrated using universal calibration (according to ISO 16014-2:2003) with 19 narrow MWD polystyrene (PS) standards in the range of 0.5 kg/mol to 11 500 kg/mol. The PS standards were dissolved at room temperature over several hours. The conversion of the polystyrene peak molecular weight to polyolefin molecular weights is accomplished by using the Mark Houwink equation and the following Mark Houwink constants:

$${K}_{PS} = 19 \times {10}^{- 3} mL / g , {α}_{PS} = 0.655 \\ {K}_{PE} = 39 \times {10}^{- 3} mL / g , {α}_{PE} = 0.725 \\ {K}_{PP} = 19 \times {10}^{- 3} mL / g , {α}_{PP} = 0.725$$

A third order polynomial fit was used to fit the calibration data.

All samples were prepared in the concentration range of 0.5−1 mg/ml and dissolved at 160° C. for 2.5 hours for PP or 3 hours for PE under continuous gentle shaking.

### Comonomer Contents

### Quantification of Microstructure by NMR Spectroscopy

Quantitative nuclear-magnetic resonance (NMR) spectroscopy was used to quantify the comonomer content of the polymers.

Quantitative ¹³C{¹H} NMR spectra recorded in the molten-state using a Bruker Advance III 500 NMR spectrometer operating at 500.13 and 125.76 MHz for ¹H and ¹³C respectively. All spectra were recorded using a ¹³C optimised 7 mm magic-angle spinning (MAS) probehead at 150° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification.{klimke06, parkinson07, castignolles09} Standard single-pulse excitation was employed utilising the NOE at short recycle delays{pollard04, klimke06} and the RS-HEPT decoupling scheme{fillip05,griffin07}. A total of 1024 (1 k) transients were acquired per spectra. Quantitative ¹³C{¹H}NMR spectra were processed, integrated and relevant quantitative properties determined from the integrals. All chemical shifts are internally referenced to the bulk methylene signal (δ+) at 30.00 ppm.

The amount of ethylene was quantified using the integral of the methylene (6+) sites at 30.00 ppm accounting for the number of reporting sites per monomer:

$$E = {I}_{δ +} / 2$$

the presence of isolated comonomer units is corrected for based on the number of isolated comonomer units present:

$$Etotal = E + ( 3 * B + 2 * H ) / 2$$

where B and H are defined for their respective comonomers. Correction for consecutive and non-consecutive commoner incorporation, when present, is undertaken in a similar way.

Characteristic signals corresponding to the incorporation of 1-butene were observed and the comonomer fraction calculated as the fraction of 1-butene in the polymer with respect to all monomer in the polymer:

$$fBtotal = ( Btotal / ( Etotal + Btotal + Htotal )$$

The amount isolated 1-butene incorporated in EEBEE sequences was quantified using the integral of the _{*}B2 sites at 38.3 ppm accounting for the number of reporting sites per comonomer:

B=I_{*B2}

The amount consecutively incorporated 1-butene in EEBBEE sequences was quantified using the integral of the ααB2B2 site at 39.4 ppm accounting for the number of reporting sites per comonomer:

BB=2*IααB2B2

The amount non consecutively incorporated 1-butene in EEBEBEE sequences was quantified using the integral of the ββB2B2 site at 24.7 ppm accounting for the number of reporting sites per comonomer:

BEB=2*IββB2B2

Due to the overlap of the *B2 and *βB2B2 sites of isolated (EEBEE) and non-consecutively incorporated (EEBEBEE) 1-butene respectively the total amount of isolated 1-butene incorporation is corrected based on the amount of non-consecutive 1-butene present:

$$B = {I}_{* B 2} - 2 * {I}_{ββ B 2 B 2}$$

The total 1-butene content was calculated based on the sum of isolated, consecutive and non consecutively incorporated 1-butene:

$$Btotal = B + BB + BEB$$

The total mole fraction of 1-butene in the polymer was then calculated as:

$$fB = ( Btotal / ( Etotal + Btotal + Htotal )$$

Characteristic signals corresponding to the incorporation of 1-hexene were observed and the comonomer fraction calculated as the fraction of 1-hexene in the polymer with respect to all monomer in the polymer:

$$fHtotal = ( Htotal / ( Etotal + Btotal + Htotal )$$

The amount isolated 1-hexene incorporated in EEHEE sequences was quantified using the integral of the _{*}B4 sites at 39.9 ppm accounting for the number of reporting sites per comonomer:

H=I_{*B4}

The amount consecutively incorporated 1-hexene in EEHHEE sequences was quantified using the integral of the ααB4B4 site at 40.5 ppm accounting for the number of reporting sites per comonomer:

HH=2*IααB4B4

The amount non consecutively incorporated 1-hexene in EEHEHEE sequences was quantified using the integral of the ββB4B4 site at 24.7 ppm accounting for the number of reporting sites per comonomer:

HEH=2*IββB4B4

The total mole fraction of 1-hexene in the polymer was then calculated as:

fH=(Htotal/(Etotal+Btotal+Htotal)

The mole percent comonomer incorporation is calculated from the mole fraction:

B [mol %]=100*fB

H [mol %]=100*fH

The weight percent comonomer incorporation is calculated from the mole fraction:

$$B [ wt \% ] = 100 * ( fB * 56.11 ) / ( ( fB * 56.11 ) + ( fH * 84.16 ) + ( ( 1 - ( fB + fH ) ) * 28.05 ) ) \\ H [ wt \% ] = 100 * ( fH * 84.16 ) / ( ( fB * 56.11 ) + ( fH * 84.16 ) + ( ( 1 - ( fB + fH ) ) * 28.05 ) )$$

### REFERENCES

Klimke, K., Parkinson, M., Piel, C., Kaminsky, W., Spiess, H. W., Wilhelm, M., Macromol. Chem. Phys. 2006; 207:382.
Parkinson, M., Klimke, K., Spiess, H. W., Wilhelm, M., Macromol. Chem. Phys. 2007; 208:2128.
Pollard, M., Klimke, K., Graf, R., Spiess, H. W., Wilhelm, M., Sperber, O., Piel, C., Kaminsky, W., Macromolecules 2004; 37:813.
Filip, X., Tripon, C., Filip, C., J. Mag. Resn. 2005, 176, 239 Griffin, J. M., Tripon, C., Samoson, A., Filip, C., and Brown, S. P., Mag. Res. in Chem. 2007 45, Si, S198.
Castignolles, P., Graf, R., Parkinson, M., Wilhelm, M., Gaborieau, M., Polymer 50 (2009) 2373.
Busico, V., Cipullo, R., Prog. Polym. Sci. 26 (2001) 443.
Busico, V., Cipullo, R., Monaco, G., Vacatello, M., Segre, A. L., Macromoleucles 30 (1997) 6251.
Zhou, Z., Kuemmerle, R., Qiu, X., Redwine, D., Cong, R., Taha, A., Baugh, D. Winniford, B., J. Mag. Reson. 187 (2007) 225.
Busico, V., Carbonniere, P., Cipullo, R., Pellecchia, R., Severn, J., Talarico, G., Macromol. Rapid Commun. 2007, 28, 1128.
Resconi, L., Cavallo, L., Fait, A., Piemontesi, F., Chem. Rev. 2000, 100, 1253.

### Density

The density was measured according to ISO 1183 and ISO1872-2 for sample preparation.

The density of intermediate fractions, that are produced in the presence of preceding polymer fractions is calculated as given below:

ρₙ=Σ(xᵢ*ρᵢ)ₙ

where xi is the mass fraction (not the mole fraction) of component i in the mixture and ρᵢ is the density of component i in the mixture and ρₙ is the density of said mixture.

### Tensile Modulus, Tensile Strength & Elongation

Tensile modulus, tensile strength and elongation were measured in machine and/or transverse direction according to ISO 527-3 on film samples prepared as described under the Film Sample preparation with film thickness of 20 μm and at a cross head speed of 1 mm/min for the modulus. For tensile strength and elongation a cross head speed of 200 mm/min is used.

### Haze and Clarity

Haze and clarity as measures for the optical appearance of the films were determined according to ASTM D1003 on film samples with a thickness of 20 μm.

### Dart Drop Strength (DDI): Impact Resistance by Free-Falling Dart Method

The DDI was measured according to ISO 7765-1:1988/Method A from the films as produced indicated below. This test method covers the determination of the energy that causes films to fail under specified conditions of impact of a free-falling dart from a specified height that would result in failure of 50% of the specimens tested (Staircase method A). A uniform missile mass increment is employed during the test and the missile weight is decreased or increased by the uniform increment after test of each specimen, depending upon the result (failure or no failure) observed for the specimen.

### Standard Conditions:

Conditioning time: >96 h
Test temperature: 23° C.
Dart head material: phenolic
Dart diameter: 38 mm
Drop height: 660 mm

### Seal Initiation Temperature

The method determines the sealing temperature range (sealing range) of polyethylene films, in particular blown films or cast films. The sealing temperature range is the temperature range, in which the films can be sealed according to conditions given below.

The lower limit (heat sealing initiation temperature (SIT)) is the sealing temperature at which a sealing strength of 5 N is achieved. The upper limit (sealing end temperature (SET)) is reached, when the films stick to the sealing device.

The measurement was done according to the slightly modified ASTM F1921-12, where the test parameters sealing pressure, delay time and grip separation rate have been modified. The determination of the force/temperature curve was continued until thermal failure of the film.

The sealing range was determined on a J&B Universal Sealing Machine Type 4000 with the films as produced indicated below, an oriented film of 20 μm thickness with the following further parameters:
Conditioning time: >96 h
Specimen width: 25 mm
Sealing pressure: 0.4 N/mm² (PE)
Sealing time: 1 sec
Delay time: 30 sec
Sealing jaws dimension: 50×5 mm
Sealing jaws shape: flat
Sealing jaws coating: Niptef
Sealing temperature: ambient −240° C.
Sealing temperature interval: 5° C.
Start temperature: 50° C.
Grip separation rate: 42 mm/see

### Examples

### Materials

LLDPE1: is FX1001 with MFR₅ 0.9 g/10 min, density 931 kg/m³, it is commercially available from Borealis.
HDPE1: is FB5600 with density 960 kg/m³, MFR 0.7 g/10 min, it is commercially available from Borouge.
LLDPE2: a mLLDPE with MFR₂ 1 g/10 min, density 917.6 kg/m³, it is produced using the polymerization parameters in Table 1.
LLDPE3: is a mLLDPE with MFR₂ 1.3 g/10 min, density 912.7 kg/m³, it is produced using the polymerization parameters in Table 1.

Table 1 shows the typical polymerization parameters and final polymer properties for LLDPE2 and LLDPE3.

TABLE 1

| | LLDPE2 | LLDPE3 |
|---|---|---|
| Prepoly reactor | | |
| Catalyst feed (g/h) | 30 | 35 |
| Temp. (° C.) | 50 | 50 |
| Press. (kPa) | 5633 | 5639 |
| C2 (kg/h) | 4.0 | 4.0 |
| H2 (g/h) | 0.04 | 0.04 |
| C4 (g/h) | 78.7 | 81.9 |
| Split (%) | 3.5 | 3.4 |
| 1st loop reactor | | |
| Temp. (° C.) | 85 | 85 |
| Press. (kPa) | 5540 | 5544 |
| C2 conc. (mol-%) | 4 | 3.5 |
| H2/C2 ratio (mol/kmol) | 0 | 0.41 |
| C4/C2 ratio (mol/kmol) | 47 | 41 |
| Split % | 18 | 17.6 |
| Density (kg/m3) | 939 | 941.0 |
| MFR2 (g/10 min) | 4.5 | 5.0 |
| 2nd loop reactor | | |
| Temp. (° C.) | 85 | 85 |
| Press. (kPa) | 5334 | 5325 |
| C2 conc. (mol-%) | 4.0 | 3.5 |
| H2/C2 ratio (mol/kmol) | 0.480 | 0.55 |
| C4/C2 ratio (mol/kmol) | 32 | 29 |
| Split (%) | 20.6 | 20.4 |
| Density (kg/m3) | 939.6 | 940.7 |
| Density (kg/m3) made in 2^{nd} loop | 940.2 | 940.4 |
| MFR2 (g/10 min) | 5.0 | 5.8 |
| MFR2 (g/10 min) made in 2^{nd} loop | 5.6 | 6.8 |
| GPR | | |
| Temp. (° C.) | 75 | 75 |
| Press. (kPa) | 2000 | 2000 |
| C2 partial Press. (kPa) | 744 | 642 |
| H2/C2 ratio (mol/kmol) | 0.83 | 1.18 |
| C6/C2 ratio (mol/kmol) | 10.9 | 14.5 |
| Density (kg/m3) made in GPR | 901.9 | 892.9 |
| MFR2 (g/10 min) made in GPR | 0.3 | 0.5 |
| Split % | 58.3 | 58.6 |
| Pellet | | |
| MFR2 (g/10 min) | 0.98 | 1.31 |
| MFR5 (g/10 min) | 2.92 | 3.86 |
| MFR21 (g/10 min) | 29.50 | 38.7 |
| Density (kg/m3) | 917.6 | 912.7 |
| C4 (wt %) | 0.6 | 0.5 |
| C6(wt %) | 7.5 | 10.9 |
| C4 (wt %) in (A) | 1.44 | 1.21 |
| C6(wt %) in (B) | 12.9 | 18.6 |

### Film Preparation

The 5 layer film before MDO was produced in Alpine 7 layers line, all of them have a start film thickness of 120 μm, the melt temperature is fixed at 210° C., BUR 1:3, the details are as follows:

### CE1:

Layer 1—HDPE1, 12 μm;
Layer 2—80% LLDPE1+20% HDPE1, 24 μm;
Layer 3—LLDPE1, 48 μm;
Layer 4—80% LLDPE1+20% HDPE1, 24 μm;
Layer 5—LLDPE2, 12 μm

### IE1:

Layer 1—HDPE1, 12 μm;
Layer 2—80% LLDPE1+20% HDPE1, 24 μm;
Layer 3—LLDPE1, 48 μm;
Layer 4—80% LLDPE1+20% HDPE1, 24 μm;
Layer 5—LLDPE3, 12 μm

### IE2:

Layer 1—HDPE1, 12 μm;
Layer 2—80% LLDPE1+20% HDPE1, 24 μm;
Layer 3—LLDPE1, 36 μm;
Layer 4—80% LLDPE1+20% HDPE1, 24 μm;
Layer 5—LLDPE3, 24 μm

The MDO was done a lab scale Alpine MDO 20 machine, with ratio of 1:6, stretching roll temperature 107° C. The final film therefore has total thickness of 20 μm. The properties of CE and IEs on MDO are shown in Table 2. As can be seen, the IEs have much lower SIT while the mechanical and optics are kept on good level.

TABLE 2

| | | CE | IE1 | IE2 |
|---|---|---|---|---|
| MD ratio | | 1:6 | 1:6 | 1:6 |
| Final thickness | μm | 20 | 20 | 20 |
| TM/MD | MPa | 1310 | 1348 | 1235 |
| Tensile strength/MD | MPa | 222.1 | 202.97 | 193.08 |
| Elogation @ MD | % | 14.94 | 13.12 | 13.07 |
| TM/TD | MPa | 544 | 538 | 395 |
| Tensile strength/TD | MPa | 29.56 | 32.49 | 32.74 |
| Elogation @ TD | % | 765.93 | 785.53 | 800.78 |
| Haze | % | 7.3 | 9.7 | 9.8 |
| Clarity | % | 93 | 91 | 91.9 |
| SIT | ° C. | 115 | 103 | 100 |
| DDI | g | 186 | 175 | 201 |
| TM(MD)*DDI/SIT | | 2118 | 2290 | 2482 |

1. A uniaxially oriented multilayer film comprising at least a sealing layer, a core layer and an outer layer, wherein at least one of said layers comprises a metallocene-catalyzed multimodal polyethylene terpolymer having a density in the range of from 910 to 916 kg/m³ and an MFR₂ (190° C., 2.16 kg, ISO 1133) in the range of from 0.1 to 2.5 g/10 min.

2. The uniaxially oriented multilayer film as claimed in claim 1, wherein said film is oriented in the machine direction.

3. The uniaxially oriented multilayer film as claimed in claim 1, wherein said film is an asymmetric film, wherein the outer layer and the sealing layer have different thicknesses.

4. The uniaxially oriented multilayer film as claimed in claim 1, wherein said multimodal polyethylene terpolymer is a terpolymer of ethylene, butene and hexene.

5. The uniaxially oriented multilayer film as claimed in claim 4, wherein said terpolymer comprises:
(i) 30.0 to 70.0 wt % of an ethylene-1-butene polymer component, and
(ii) 70.0 to 30.0 wt % of an ethylene-1-hexene polymer component.

6. The uniaxially oriented multilayer film as claimed in claim 1, wherein the sealing layer comprises at least 50.0 wt % of the multimodal polyethylene terpolymer, relative to the total weight of the layer.

7. The uniaxially oriented multilayer film as claimed in claim 1, wherein said film comprises 3, 4 or 5 layers.

8. The uniaxially oriented multilayer film as claimed in claim 1, further comprising one or more tie layers.

9. The uniaxially oriented multilayer film as claimed in claim 1, wherein said outer layer comprises a polyethylene having a density of 945 to 975 kg/m³ and an MFR₂ (190° C., 2.16 kg, ISO 1133) in the range of from 0.1 to 4.0 g/10 min.

10. The uniaxially oriented multilayer film as claimed in claim 1, wherein said core layer comprises a polyethylene having a density of 925 to 945 kg/m³ and an MFR₅ (190° C., 2.16 kg, ISO 1133) in the range of from 0.1 to 2.5 g/10 min.

11. The uniaxially oriented multilayer film as claimed in claim 1, wherein said film has a tensile modulus (TM) in the machine direction (MD) of 800 to 4000 MPa, determined according to ISO 527-3 on 20 μm films.

12. The uniaxially oriented multilayer film as claimed in claim 1, wherein said film has a haze of 12% or lower, determined according to ASTM D1003 on film samples with a thickness of 20 μm.

13. The uniaxially oriented multilayer film as claimed in claim 1, wherein said film has a seal initiation temperature (SIT) of less than 115° C.

14. The uniaxially oriented multilayer film as claimed in claim 1, wherein said film is a blown film, before stretching.

15. An article comprising the uniaxially oriented multilayer film as claimed in claim 1.

16. A method of use of a metallocene-catalyzed multimodal polyethylene terpolymer having a density in the range of from 910 to 916 kg/m³ and an MFR₂ (190° C., 2.16 kg, ISO 1133) in the range of from 0.1 to 2.5 g/10 min, the method comprising using the metallocene-catalyzed polyethylene terpolymer in the production of the uniaxially oriented multilayer film as claimed in claim 1.

17. The uniaxially oriented multilayer film as claimed in claim 1, wherein the sealing layer comprises the metallocene-catalyzed multimodal polyethylene terpolymer.

18. The uniaxially oriented multilayer film as claimed in claim 4, wherein said terpolymer consists of:
(i) 30.0 to 70.0 wt % of an ethylene-1-butene polymer component, and
(ii) 70.0 to 30.0 wt % of an ethylene-1-hexene polymer component.

19. The uniaxially oriented multilayer film as claimed in claim 1, wherein the sealing layer comprises at least 70.0 wt % of the multimodal polyethylene terpolymer, relative to the total weight of the layer.

20. The article of claim 15, wherein the article is a packaging article.
